(19) United States
(12) Patent Application Publication
(10) Pub. No.: US 2010/0224442 A1
(43) Pub. Date: Sep. 9, 2010

(54) SOUND BARRIER PANEL

(76) Inventor: Mark Sanders, Zionsville, IN (US)

Correspondence Address: MAGINOT, MOORE & BECK, LLP;CHASE TOWER, 111 MONUMENT CIRCLE, SUITE 3250, INDIANAPOLIS, IN, 46204, US

(21) Appl. No.: 12/718,201

(22) Filed: Mar. 5, 2010

Related U.S. Application Data
(60) Provisional application No. 61/158,645, filed on Mar. 9, 2009.

(51) Int. Cl. E04B 1/84; B29C 45/14; B32B 37/24

(52) U.S. Cl. 181/294; 264/279; 156/242

(57) ABSTRACT

A sound barrier panel is providing having a concrete substrate and a noise attenuation layer forming a composite panel, in which the noise attenuation layer is formed of recycled shredded rubber and a binder.

### REFERENCE TO RELATED APPLICATION

The present application claims priority to co-pending provisional application No. 61/158,645, entitled “Sound Barrier Panel”, filed on Mar. 9, 2009, the disclosure of which is incorporated herein by reference in its entirety.

### BACKGROUND

In recent years, state highway commissions or transportation departments have promulgated noise level standards for highways passing through urban neighborhoods. As population densities in urban areas increase, it is a virtual certainty that residential neighborhoods will be adjacent a high speed throughway. Even in suburban areas, the desire for ready access to highways and interstates prompts residential development in close proximity to these roads.

Highway noise can greatly impact quality of life for the nearby residents. The federal Environmental Protection Agency has determined that noise levels above 66 decibels are unsafe for residential areas, while 72 dB is the limit for commercial environments. It has been suggested that high decibel levels along the highways may be linked to hearing loss, high blood pressure, irritability, ulcers, and heartburn, among other ailments. A standard pickup truck at 50 mph produces noise at 70 dB, while a medium truck is twice as loud at 80 dB. A motorcycle can reach 90 dB, which is four times louder than the pickup truck. Highway noise is not just a function of the inherent noisiness of each vehicle. For instance, highway noise doubles when the traffic increases from 200 vehicles per hour to 2000 vehicles per hour, or when traffic speed increases from 30 mph to 65 mph. A single semi-trailer truck at 55 mph produces as much noise as ten cars at the same speed. It is not hard to see that highway noise in densely populated urban environments can quickly become unbearable.

Many approaches have been devised to address the problem of road noise. Some noise abatement systems involve designing the roads themselves to reduce vehicle noise. Lower highway speed limits within city limits can reduce noise. For new development, buffer zones are provided between the residential or commercial buildings and the highway. But for many older neighborhoods, traffic volume has steadily increased over the years as the traffic flow on the adjacent roads has increased. For these neighborhoods, sound barriers are the most viable solution.

Effective noise abatement systems can reduce sound levels 10-15 dB, cutting the loudness of the traffic in half. Where space permits, earth barriers are relative inexpensive and can be used to improve the ecological aesthetics of the neighborhood. This approach is common for new neighborhoods but not often available for existing residential areas. Walls, on the other hand, take up less space. Generally, such walls are limited to 25 feet in height for structural and aesthetic reasons. Noise walls may be built from wood, stucco, concrete, masonry, metal and similar materials.

Concrete sound barrier walls are frequently used because are very weather resistant. Moreover, the ability to produce pre-fabricated concrete panels can simplify construction, while also providing the ability to add aesthetic features to the panels. However, concrete panels can require periodic maintenance or even complete replacement as the barriers become damaged or pitted from debris, acid rain and other environmental factors.

### SUMMARY

In accordance with one aspect of the invention, a sound barrier panel is provided comprising a concrete substrate and a noise attenuation layer, together formed as a composite panel. The noise attenuation layer is formed of recycled shredded rubber and a binder. In certain embodiments, a backing sheet is interposed between the concrete substrate and the noise attenuation layer, in which the backing sheet is formed of a material that can readily bond to both the concrete substrate and the noise attenuation layer.

In one embodiment, the concrete substrate and the noise attenuation layer are formed in a common mold. In another embodiment, the noise attenuation layer itself forms a mold into which the concrete substrate is formed.

In certain embodiments, the noise attenuation layer is formed from about 10 lbs. of recycled shredded rubber per square foot of surface area of noise attenuation layer. Recycled shredded plastic and/or shredded fiberglass may also be added to the noise attenuation layer. The noise attenuation layer is preferably formed with about 25% by volume of binder. The recycled shredded rubber is preferably shredded to a thickness of no greater than about one inch and an area of about 5 to about 16 sq.in.

The concrete substrate may include reinforcing elements such as rebar or wire mesh. The noise attenuation layer may include a base panel and a plurality of post projecting therefrom, with the reinforcing elements are supported on the plurality of posts.

In another aspect, the noise attenuation layer may include a plurality of fingers projecting outward from a surface opposite the surface facing said concrete substrate. Each of the plurality of fingers is generally hook-shaped, preferably formed to curl inward toward the surface of the layer. The fingers are resiliently deflectable.

In another aspect of the invention, a method is provided for forming a pre-cast sound barrier panel comprising the steps of pouring a first mixture of recycled shredded rubber and a binder into a mold, allowing the mixture to cure, and then pouring a concrete-forming mixture onto the first mixture within the same mold. In one embodiment, the method comprises the further step of applying an intermediate sheet on said first mixture before it cures, the intermediate sheet formed of a material capable of bonding to concrete. In another embodiment, the first mixture is poured to form a second mold into which the second concrete-forming mixture is poured.

### DESCRIPTION OF THE FIGURES

FIG. 1 is a perspective view of a sound barrier panel according to one embodiment of the present invention.

FIG. 2 is an end view of the composite panel shown in FIG. 1.

FIG. 3 is a side cross-sectional view of a composite panel according to a further embodiment.

FIG. 4 is an enlarged view of a feature of the panel shown in FIG. 3.

### DESCRIPTION OF THE EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

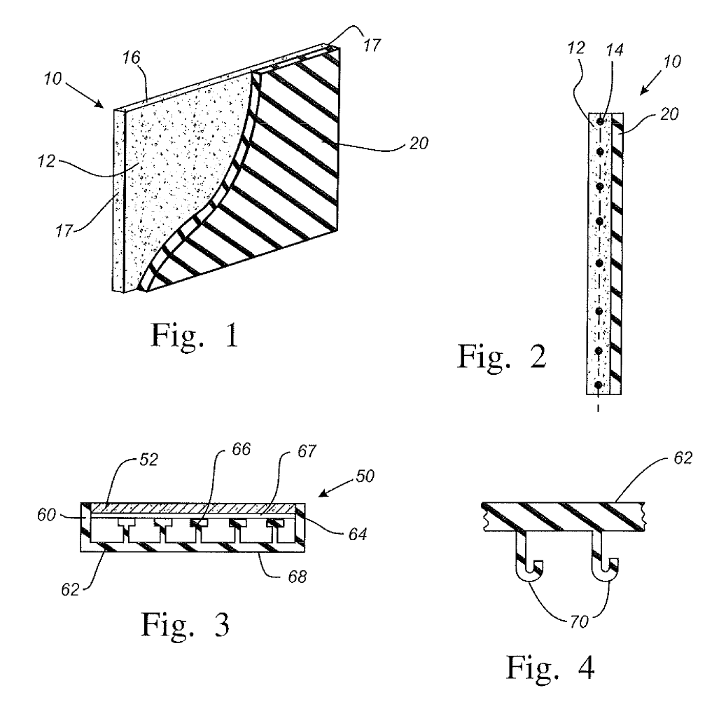

According to one aspect of the invention, a sound barrier panel 10 includes a substrate 12 and a noise attenuation layer 20, as shown in FIGS. 1 and 2. The substrate 12 is preferably a pre-formed or pre-molded concrete panel. The substrate may include reinforcing members 14 throughout the panel, such as rebar or wire mesh. The substrate 12 may incorporate various known elements for lifting the panel 10, for interconnecting panels or for supporting the panel at the job site, all as dictated by the particular needs. For instance, lifting bolt threaded inserts may be provided at the top edge 16 of the substrate 12 for engagement with lifting cables. The lateral edges 17 may be formed as lap joints or in some other interlocking configuration to integrate with an adjacent panel. Alternatively, connector plates may be embedded in the lateral edges 17. It is contemplated that the substrate 12 can be formed according to the design needs of the particular noise abatement system.

In a further aspect of the invention, the noise attenuation layer 20 is formed from a composite of recycled materials molded into a solid matrix. In one embodiment, the recycled materials includes recycled rubber and/or plastic provided in the form of chips. The chips can be obtained form shredding waste rubber, such as tires, and waste plastic articles, such as containers. The waste materials are preferably shredded or processed to form chips preferably having a thickness of no greater than one inch and an area of about 5 to about 16 sq.in. to accommodate a typical panel dimension. In particular, the noise attenuation layer 20 can have a thickness in the range of 2-5 inches, depending on the amount of noise attenuation desired.

The attenuation layer may optionally include waste fiberglass. The fiberglass is preferably shredded or processed in the same manner as the waste rubber and plastic and to the same general dimensions. In some cases, the waste fiberglass may be provided in a mesh form, such as fiberglass insulation. The mesh fiberglass is also preferably processed to provide the waste mesh material in about the same dimensions as the other components.

In preparing the noise attenuation layer, the processed recycled materials may be combined into a single batch of chips. The chips are poured into a sheet mold, preferably concurrently with a binder material. The binder material in one embodiment is a resin that is sufficiently viscous to be easily poured into the mold with the recycled chips. The resin is hardenable to form a complete composite layer. Alternatively, the binder may be a polyurethane binder, such as a prepolymer based on diphenylmethane-diisocyanate together with a catalyst, such as N,N′-dimorpholinodiethylether. The binder may be provided as approximately 25% by volume of the noise attenuation layer 20. In a preferred embodiment, the processed recycled materials include recycled shredded rubber chips at about 10 lbs per square foot of attenuation layer 20.

In one embodiment, the base of the mold is provided with a plastic backing sheet with the recycled materials and the binder material being poured onto the backing sheet. Alternatively, the backing sheet may be added to the top of the newly poured composite layer. The backing sheet will adhere to the noise attenuation layer, and more particularly to the binder. The backing sheet can act as an interface with the underlying substrate, and particularly as a bonding interface. It may be contemplated that the waste materials forming the noise attenuation layer may not be readily bonded to the material of the substrate 12 when it is poured. The plastic sheet provides a uniform surface that can be bonded to a wide variety of substrate materials, particularly including wood and concrete.

In certain embodiments, the noise attenuation layer may form the base for molding the substrate material to complete the panel construction. Thus, the framework defining the panel mold is sized to accommodate a first “pour” for the attenuation layer and a second “pour” for the substrate. In a preferred embodiment, the substrate is concrete or a concrete mix with recycled product. In the latter case, the concrete mix may incorporate 5-10% by volume recycled shredded rubber and/or plastic. Once the noise attenuation layer has cured within the mold framework, the concrete may be poured onto the plastic backing sheet to bond. As the concrete cures it may bond to the backing sheet to form the complete composite sound panel.

The panels 10 have a height and length that is determined by the needs at the job site. The thickness of the substrate 12 will preferably range from 4-6 inches, with a most preferred thickness of 4¼ inches. The thickness of the noise attenuation layer 20 can be sized according to the desired noise attenuation characteristics of the layer, but will typically range from 2-5 inches as described above. The framework or mold for the composite panel is therefore preferably 6-12 inches thick to form the two layers of the panel.

In a second embodiment, a composite noise attenuation panel 50 shown in FIG. 3 includes a substrate 52 and an attenuation layer 60. In this embodiment, the attenuation layer itself forms the mold for the substrate. Thus, in one embodiment the attenuation layer is formed of recycled plastic, rubber or a composite thereof. The recycled material is processed to a form that is pourable and moldable, such as by comminuting waste plastic and/or rubber and melting the resulting powder. The resulting liquid may be augmented by additives for color or strength, for instance. The pourable recycled material is poured into a mold to form the material itself into a mold-shape. Thus, the resulting attenuation layer 60 includes a base panel 62 and side perimeter walls 64. Once the attenuation layer cures the substrate may be poured directly into the form to complete the composite noise attenuation panel. The substrate is preferably concrete.

In a further aspect, the interior of the mold-shaped layer 60 may include support posts 66 projecting upward from the base panel 62. These posts 66 provide support for reinforcing members 67, such as rebar. Once the attenuation layer 60 cures, the rebar may be positioned on the array of support posts and the substrate 52 poured.

A further enhancement may be incorporated into the facing side 68 of the base panel 62. The facing side 68 is the side that is exposed when the noise attenuation panel is installed. The facing side may be molded with an array of curled or hook-shaped fingers 70, as shown in the detail view of FIG. 4. These fingers are formed to curl inward toward the base panel 62 to enhance the noise attenuation characteristics of the panel. The fingers 70 are preferably resilient so that the molded and cured fingers may be removed from the underlying mold by “uncurling” the fingers as the base panel is pulled from the mold, after which the resilient fingers return to their curled configuration. In addition, the resilience of the fingers can improve the survivability of the panel in use. Finally, the irregular aspect presented by the fingers 70 reduces the ability of vandals to place graffiti on the panels. The fingers 70 may be formed of the binder material of the noise attenuation layer, preferably without the recycled shredded material embedded therein.

In accordance with the present invention, the concrete substrates 12, 52 may be modified as desired for particular considerations, such as strength, cost, weather resistance, aesthetics and the like. Thus, additives may be combined with the cement used to form the concrete substrate, such as plasticizers, sealants and pigments. Some variation in the materials of the noise attenuation layers 20, 60 may be acceptable, although significant modifications may compromise the sound transmission loss performance of the panel. It is therefore preferred that any materials added to the noise attenuation layer have sufficient sound absorption qualities.

One aspect of the panels 10, 50 of the present invention is that they can be easily precast at a manufacturing facility remote from the installation site. A number of identical molds may be used to produce a quantity of uniform panels, or a single mold may be used to produce a length of panel that is cut to size. The precast panels may be formed in fixed molds, by slip-forming, or by other known techniques for fabricating pre-cast concrete panels. With respect to the embodiment of FIG. 3, the noise attenuation layer 60 may be pre-formed and shipped to the job site where the concrete layer 52 is added.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A sound barrier panel comprising:
a concrete substrate; and
a noise attenuation layer formed of recycled shredded rubber and a binder, said noise attenuation layer and said concrete substrate combined to form a composite panel.

2. The sound barrier panel of claim 1, wherein said concrete substrate and said noise attenuation layer are physically bonded.

3. The sound barrier panel of claim 2, wherein a backing sheet is interposed between said concrete substrate and said noise attenuation layer, said backing sheet formed of a material that can readily bond to both the concrete substrate and the noise attenuation layer.

4. The sound barrier panel of claim 1, wherein said concrete substrate and said noise attenuation layer are formed in a common mold.

5. The sound barrier panel of claim 1, wherein said noise attenuation layer is formed from 10 lbs. of recycled shredded rubber per square foot of surface area of noise attenuation layer.

6. The sound barrier panel of claim 5, wherein said noise attenuation layer is further formed from about 25% by volume of binder.

7. The sound barrier panel of claim 1, wherein said noise attenuation layer further includes recycled shredded plastic.

8. The sound barrier panel of claim 1, wherein said noise attenuation layer further includes recycled shredded fiberglass.

9. The sound barrier panel of claim 1, wherein said recycled shredded rubber is shredded to a thickness of no greater than about one inch and an area of about 5 to about 16 sq.in.

10. The sound barrier panel of claim 1, wherein said concrete substrate includes reinforcing elements selected from rebar or wire mesh.

11. The sound barrier panel of claim 10, wherein:
said noise attenuation layer includes a base panel and a plurality of post projecting therefrom; and
said reinforcing elements are supported on said plurality of posts.

12. The sound barrier panel of claim 1, wherein said concrete substrate includes recycled shredded material selected from recycled rubber, recycled plastic and recycled fiberglass.

13. The sound barrier panel of claim 1, wherein said noise attenuation layer includes side walls forming a mold for receiving said concrete substrate.

14. The sound barrier panel of claim 1, wherein said noise attenuation layer includes a plurality of fingers projecting outward from a surface opposite the surface facing said concrete substrate.

15. The sound barrier panel of claim 14, wherein each of said plurality of fingers is generally hook-shaped.

16. The sound barrier panel of claim 15, wherein said hook-shape of each of said fingers curls inward toward said surface.

17. The sound barrier panel of claim 15, wherein said fingers are resiliently deflectable.

18. A method for forming a pre-cast sound barrier panel comprising:
pouring a first mixture of recycled shredded rubber and a binder into a mold;
allowing the mixture to cure; and then
pouring a concrete-forming mixture onto the first mixture within the same mold.

19. The method for forming a pre-cast sound barrier panel of claim 18, further comprising the step of applying an intermediate sheet on said first mixture before it cures, the intermediate sheet formed of a material capable of bonding to concrete.

20. The method for forming a pre-cast sound barrier panel of claim 18 wherein the first mixture is poured to form a second mold into which the second concrete-forming mixture is poured.
